(19) United States
(12) Patent Application Publication
(10) Pub. No.: US 2020/0347620 A1
(43) Pub. Date: Nov. 5, 2020

(54) Sealed Disposable Concrete Vibrator

(71) Applicant: Multiquip, Inc., Boise, ID (US)

(72) Inventors: Tyler N. Clements, Boise, ID (US); Christopher G. Gilbert, Theresa, NY (US)

(73) Assignee: Multiquip, Inc., Boise, ID (US)

(21) Appl. No.: 16/398,781

(22) Filed: Apr. 30, 2019

(51) Int. Cl. E04G 21/08; B01F 11/00; B06B 1/16

(52) U.S. Cl. CPC E04G 21/08; B01F 2215/0047; B06B 1/16; B01F 11/0097

(57) ABSTRACT

A sealed disposable concrete vibrator assembly includes a hollow cylindrical main housing enclosing a shaft having an eccentric mid portion sized to rotate therewithin. Sealed bearings supporting the shaft are encased within an adaptor housing and a tip cover attached concentrically to proximal and distal ends, respectively, of the main housing. Outer surfaces of the adaptor housing and tip cover protrude into the main housing for frictional engagement therewith, while inner surfaces thereof provide channels to encase the bearings. An oil seal compressed against a flange integral to the adaptor housing prevents intrusion of contaminants. A circumvolving adaptor is coupled through the oil seal to the driven end of the shaft. The assembly may be hermetically sealed by permanent attachment of the adaptor housing and tip assembly to the main housing.

### TECHNICAL FIELD

The presently disclosed technology relates to concrete vibrators intended for immersion in newly poured, low slump concrete of the type commonly used for construction of concrete columns, where the vibrators are used to eliminate air pockets in newly poured concrete by consolidating the newly poured concrete.

### BACKGROUND

Vertical columns for bridges and multi-story buildings are typically made of concrete, reinforced by rebar, which is often coated with some sort of plastic and fabricated using very dense, somewhat dry, low flowability, low slump concrete. This is done to achieve the maximum compressive value reasonably available to attain the highest compressive strength columns that may be required or can be achieved. Typically, these columns are poured in place, and are heavily reinforced with rebar, which is often wired together to increase the shear strength of the vertical column. The rebar itself, often in order to extend its useful life, is coated in plastic material to minimize the corrosive effects of the alkaline environment within the poured concrete, and along with the entrained or later absorbed moisture, which may be found in the concrete which is exposed to the elements.

Unfortunately, relatively dry, low slump concrete does not flow well and the concrete must be consolidated, that is to say the air pockets must be removed from the concrete to ensure structural integrity of the vertical columns. This is done using an immersible concrete vibrator which is dropped from the top into the recently poured concrete to vibrate the concrete to remove the air pockets in the preformed column of concrete.

The typical prior art concrete vibrators typically incorporate the same basic design features, although they may vary in size and shape with minor design changes. The typical prior art concrete vibrator is formed of a hollow canister having a tip assembly at one end, and a driven end and coupler at the other end, which is attached to a rotatable eccentric shaft which, being actually out of balance, induces a vibration in the vibrator when the shaft is rotating which is transmitted through the canister to the concrete and is used to move the concrete to consolidate and eliminate air pockets. The rotatable eccentric shaft is usually mounted on bearings of one design or another which are positioned between the interior diameter of the canister and the rotating eccentric shaft itself. Some prior art vibrators are filled with machine oil of one grade or another. Others rely upon sealed bearings to transmit the vibration induced by the rotating eccentric shafts to the outer casing of the vibrator. Obviously, the bearings supporting the rotating eccentric shaft are subjected to continuously variable and high stress loads. These bearings seem to be the weak link in the design, and the prior art concrete vibrators are designed and fabricated such that they can be disassembled so that the bearings may be periodically replaced.

This prior art assumption, that a key feature of an immersible concrete vibrator is the ability to disassemble the vibrator to facilitate the replacement of the bearings, is the root cause of a number of problems in the prior art. The first of which is that it poses a requirement that the tip cover at the non-driven end of the vibrator as well as the adaptor coupler at the driven end have to be removable. This results in a number of expensive machining processes to provide for a threaded screw or breach lock mechanism at each end of the vibrating canister, along with the attendant and appropriate oil seals, to prevent contamination of the interior of the vibrator by concrete when it is immersed in newly poured concrete and in operation. The actual useful life of the bearings supporting a rotatable eccentric shaft within an immersible concrete vibrator varies greatly with the quality of the materials and bearings used, and adherence to proper operating instructions. In particular, these concrete vibrators are typically driven using a flexible drive shaft or cable, which are turned on when the vibrator is immersed in the concrete and quickly turned off as the vibrator is withdrawn from the concrete. If the operator fails to turn off the concrete vibrator when it is not immersed in concrete, the concrete vibrator will rapidly overheat the bearing surfaces to the point where they require replacement. Another problem is that even though the prior art concrete vibrator is designed to be disassembled so that bearings may be replaced as routine maintenance requires, the routine maintenance is often postponed or not performed at all, usually because of cost, or problems locating proper sized bearing assemblies, or absence of skilled mechanics trained in the proper installation of new bearing assemblies. Since the extra machining steps involved in producing a concrete vibrator that can be disassembled are significant, replacement costs are accordingly expensive.

What is needed is an inexpensive way of manufacturing and providing an immersible concrete vibrator of rugged design that is, in effect, disposable. To achieve this objective it is necessary to provide a design which minimizes the machining requirements for production and assembly of the concrete vibrator to reduce cost, yet at the same time provides a rugged and simple design not prone to premature failure.

### SUMMARY OF THE INVENTION

The purpose of the Summary Section is to enable the public, and especially the scientists, engineers, and practitioners in the art who are not familiar with patent or legal terms or phraseology, to determine quickly from a cursory inspection, the nature and essence of the technical disclosure of the application. This Summary is neither intended to define the inventive concepts of the application, which is measured by the claims, nor is it intended to be limiting as to the scope of the inventive concepts in any way.

In one embodiment of the invention, a sealed and disposable concrete vibrator (also referred to herein as a “concrete vibrator assembly”, “vibrator assembly”, or simply “vibrator”) is provided with a hollow main housing which is open at both proximal and distal ends. The main housing is preferably cylindrical, and may be formed either from a casting or from a fabricated metal tube and is provided with an inner machined surface at its distal end that is sized to frictionally engage with an attachment sleeve of a tip cover, and also with an inner machined surface at its proximal end that is sized to frictionally receive and hold an attachment sleeve of an adaptor housing. Accordingly, the tip cover is provided with an attachment sleeve sized for frictional engagement with the distal end of the main housing. The attachment sleeve may be integrally formed on the tip cover, and may be permanently attached to the main housing by gluing or welding. Similarly, the adaptor housing is provided with an attachment sleeve sized for frictional engagement with the proximal end of the main housing, which attachment sleeve may be integrally formed on the adaptor housing, and which may be permanently attached to the main housing by gluing or welding.

The interior centerlines of the main housing, tip cover, and adaptor housing are preferably in axial alignment with one another and with bearing surfaces of an eccentric shaft installed within the main housing. The eccentric shaft is a shaft that is out of balance when rotating and thus imparts a vibration to the disposable concrete vibrator when rotating. One or more proximal end sealed bearings frictionally engage a machined inner bearing surface of the adaptor housing attachment sleeve and support the driven end of the rotating eccentric shaft, and one or more distal end sealed bearings frictionally engage a machined inner surface of the tip cover attachment sleeve and support the nondriven end of the rotating eccentric shaft.

The rotating eccentric shaft may be fabricated from manufactured steel, forged or cast or powdered metal materials or a composite, depending upon model design. The main housing and tip cover are typically hardened to extend life. In a preferred embodiment, the main housing and the outer surface of the tip cover are encased in plastic or a rubber-like material so that the concrete vibrating assembly may be used with plastic coating rebar applications without damaging or stripping away the plastic coating on the rebar.

A flexible drive shaft adaptor is accommodated within the adaptor housing and is attached to the driven end of the rotating eccentric shaft. The adaptor housing and design may vary depending upon the flexible drive shaft interface intended to be used with a particular concrete vibrator assembly. Similarly, the design features of the flexible drive shaft adaptor may depend on the design of the eccentric drive shaft to which the adaptor is intended to be connected. In between the adaptor housing and the proximal end sealed bearings is an oil seal of suitable dimensions and materials to seal the concrete vibrator assembly to prevent contamination of the interior of the vibrator during operation and when immersed in concrete, and to prevent leakage of lubricant out of the main housing.

A method for manufacturing a sealed disposable concrete vibrator is also provided. Salient steps of the method include: providing a main housing having open proximal and distal ends, providing a tip cover having a bearing channel and having an attachment sleeve configured to frictionally engage the distal end of the main housing, fitting one or more bearings within the bearing channel of the tip cover, bonding the attachment sleeve of the tip cover to the distal end of the main housing, providing an adaptor housing having a bearing channel and having an attachment sleeve configured to frictionally engage the proximal end of the main housing, fitting one or more bearings within the bearing channel of the adaptor housing, installing a driven end of an eccentric shaft concentrically through the one or more bearings of the adaptor housing, coupling a drive shaft adaptor to the driven end of the eccentric shaft, installing a nondriven end of the eccentric shaft within the one or more bearings of the tip cover, and bonding the attachment sleeve of the adaptor housing to the proximal end of the main housing.

As can be seen in the preferred embodiment, the machining steps necessary to create a vibrator according to the invention are minimal, thus greatly reducing the cost and ultimate sale price of the vibrator. It has also been found that a vibrator of the present invention, though relatively simple and rugged in design, will have as long a service life as the much more expensive, disassembleable, concrete vibrators known in the prior art and that cost savings achieved through this design, when taken together with the avoided cost of replacement bearings and labor to rebuild a more expensive concrete vibrator, more than economically justify the use of the sealed disposable concrete vibrator assembly of the present invention.

Still other features and advantages of the presently disclosed and claimed inventive concepts will become readily apparent to those skilled in this art from the following detailed description describing preferred embodiments of the inventive concepts, simply by way of illustration of the best mode contemplated by carrying out the inventive concepts. As will be realized, the inventive concepts are capable of modification in various obvious respects all without departing from the inventive concepts. Accordingly, the drawings and description of the preferred embodiments are to be regarded as illustrative in nature, and not as restrictive in nature.

### BRIEF DESCRIPTION OF THE DRAWINGS

FIG. 1 is a cross sectional side view of a sealed disposable concrete vibrator according to one embodiment of the present invention.

FIG. 2 is a flow chart showing salient steps in a method for manufacturing a sealed disposable concrete vibrator according to one embodiment of the invention.

### DETAILED DESCRIPTION OF THE INVENTION

While the presently disclosed inventive concepts are susceptible to various modifications and alternative constructions, certain illustrated embodiments thereof have been shown in the drawings and will be described below in detail. It should be understood, however, that there is no intention to limit the inventive concepts to the specific form disclosed, but, on the contrary, the presently disclosed and claimed inventive concepts are to cover all modifications, alternative constructions, and equivalents falling within the spirit and scope of the inventive concepts as defined in the claims.

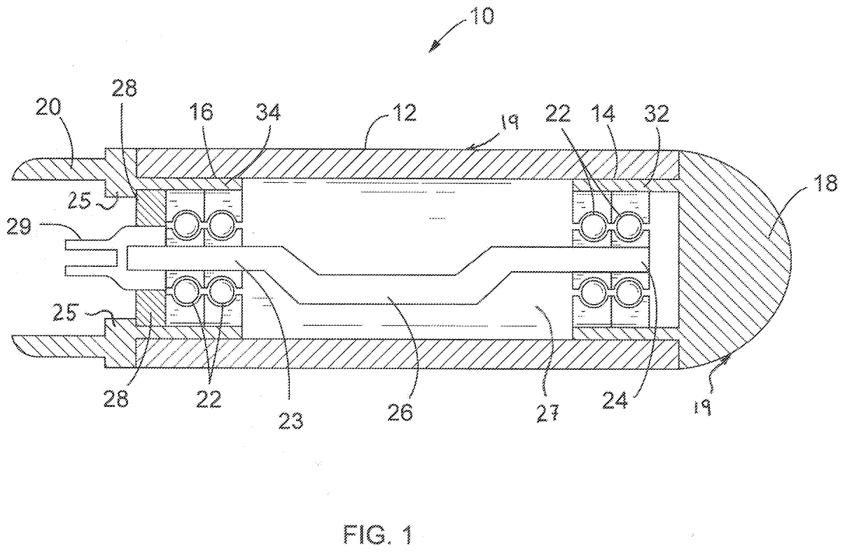

FIG. 1 shows a sectional representation of a side view of our new sealed disposable concrete vibrator 10. Provided is a main housing 12, which, in the preferred embodiment, is of hollow cylindrical form open at both proximal and distal ends. Main housing 12 may be formed either from a casting or from a fabricated metal tube and may be provided with a distal end machined inner surface 14 sized to frictionally engage, or interfit, with attachment sleeve 32 of tip cover 18. Main housing 12 is also provided with a proximal end machined inner surface 16 at the proximal end (or driven end) of main housing 12, which proximal end machined inner surface 16 is sized to frictionally receive and hold an attachment sleeve 34 of an adaptor housing 20. Accordingly, tip cover 18 and its attachment sleeve 32 are sized for frictional engagement with the distal opening of main housing 12, such that attachment sleeve 32 interfits, or sealingly engages, within distal end machined inner surface 14. In one embodiment, tip cover 18 may be permanently attached to the main housing 12 along the interface of attachment sleeve 32 and machined inner surface 14 by means of a suitable adhesive or glue, or even something as simple as an adhesive formulation of the type marketed by Loctite®. In another embodiment, the tip cover 13 may be permanently attached to main housing 12 by welding.

When the concrete vibrating assembly 10 is fully assembled, as shown in FIG. 1, the interior longitudinal centerlines of main housing 12, tip cover 18 and adaptor housing 20 are preferably in axial alignment with one another and with the bearing surfaces of eccentric shaft 26. When these components are so aligned, they are said to be concentrically installed or concentrically aligned, with that alignment being along an imaginary longitudinal axis running through the center of the main housing 12. Preferably, main housing 12 has axial symmetry about the longitudinal axis.

Eccentric shaft 26 may be a shaft of well known design that inherently out of balance when rotating and thus able to impart a vibration to concrete vibrating assembly 10 when rotating. A pair of proximal end sealed bearings 22 frictionally engage a channel configured to securely hold the bearings, the channel formed in space between the machined inner surface of adaptor housing attachment sleeve 34, so that the bearings 22 support the driven end 23 of the rotating eccentric shaft 26. A pair of distal end sealed bearings 22 frictionally engage a similar channel formed in space between the machined inner surface of tip cover attachment sleeve 32, so that the bearings 22 support the nondriven end 24 of rotating eccentric shaft 26. In a like manner to the tip cover 18, the adaptor housing attachment sleeve 34 of adaptor housing 20 is provided with an outer surface that frictionally engages with machined surface 16 formed in the proximal end of main housing 12, and which may be sealingly attached to machine surface 16 by gluing or welding.

Rotating eccentric shaft 26 may be manufactured from machined steel, may be forged or cast or formed from powdered metal materials or a composite, depending upon model design. The main housing 12 and tip cover 18 are typically hardened to extend life. In a preferred embodiment, the main housing 12 and the outer surface of the tip cover 18 are encased in plastic or a rubber-like material 19 so that the concrete vibrating assembly 10 may be used with plastic coating rebar applications without damaging or stripping away the plastic coating on the rebar. In another embodiment, the hollow cavity of main housing 12 may be completely or at least partially filled with a lubricating medium 27, such as grease, oil, graphite, or the like.

As shown in FIG. 1, the adapter housing 20 is configured to accommodate a flexible drive shaft adaptor 29. The flexible drive shaft adaptor 29 may be provided as a means for coupling a prime mover, such as an electric motor, to the driven end of rotating eccentric shaft 26, to thereby circumvolve the shaft. The specific design of adaptor housing 20 may therefore vary depending upon the flexible drive shaft interface intended to be used with a particular concrete vibrator assembly 10. Similarly, the design features of the flexible drive shaft adaptor 30 may depend on the design of the eccentric drive shaft to which the adaptor is intended to be connected.

In one embodiment, an oil seal 28 is installed between one or more sealed bearings 22 and an oil seal flange 25. Preferably, the oil seal flange 25 is integrally formed on the adaptor housing 20 so that it will arrest longitudinal movement of the oil seal 28 in a proximal direction. Properly installed, longitudinal movement of the oil seal 28 in a distal direction will be arrested by bearings 22. Oil seal 28 is made of suitable dimensions and materials to seal the vibrator 10 to prevent contamination during rotation of eccentric shaft 26, and when immersed in concrete, and to prevent leakage of the lubricating medium 27.

In view of the foregoing descriptions, one skilled in the relevant art will recognize that the present invention may be expressed as a sealed disposable concrete vibrator assembly that includes a hollow cylindrical main housing enclosing a shaft rotationally supported by bearings, wherein the shaft has an eccentric mid portion rotatable within the main housing. In addition, the vibrator assembly includes an adaptor housing having a cylindrical protrusion having an outer surface configured to frictionally engage a proximal end of the main housing and having an inner surface configured to frictionally engage one or more of the bearings. In addition, the vibrator assembly includes a tip cover having a cylindrical protrusion having an outer surface configured to frictionally engage a distal end of the main housing and having an inner surface configured to frictionally engage one or more of the bearings. In addition, the vibrator assembly includes an oil seal compressed against a flange integral to the adaptor housing, and a circumvolving adaptor coupled through the oil seal to a driven end of the shaft. According to the invention, frictional engagement of the adaptor housing to the main housing, and/or frictional engagement of the tip cover to the main housing, closes open end(s) of the main housing and reliably seals the hollow interior of the main housing against intrusion of foreign material. The engagement of the adaptor housing and tip cover may be effected by press-fitting alone, or it may also include bonding the adaptor housing and tip cover to the main housing by a permanent attachment means such as gluing or welding, to create a hermetic seal.

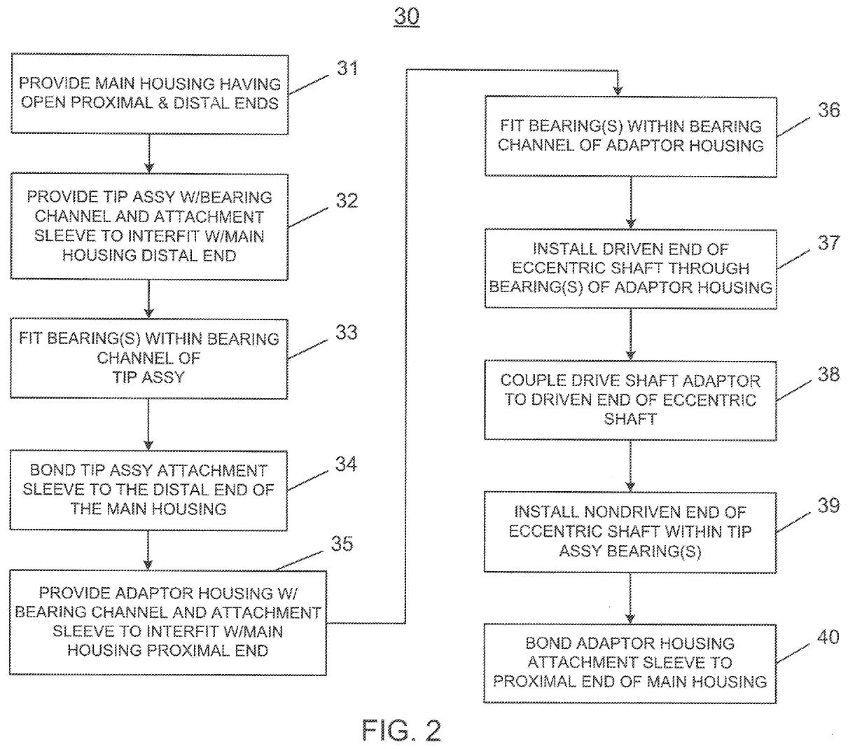

FIG. 2 shows a flow chart that illustrates salient steps in a method 30 for manufacturing a sealed disposable concrete vibrator 10 according to one embodiment of the invention. The steps of method 30 may be performed in any order desired, as the invention does not restrict performance of the method to the precise order of steps shown.

With the foregoing description of the vibrator 10 in mind, the salient steps of method 30 are expressed as follows: In an initial step 31, a main housing is provided for the vibrator assembly. The main housing is provided with open proximal and distal ends, and may consist of a cylinder such as a pipe section. Next, step 32 requires providing a tip cover having a bearing channel and having an attachment sleeve configured to frictionally engage the distal end of the main housing. During performance of this step, the attachment sleeve of the tip cover may be integrally formed on the tip cover. The next step 33 requires fitting one or more bearings within the bearing channel of the tip cover. The next step 34 requires bonding the attachment sleeve of the tip cover to the distal end of the main housing. The bond may be made permanent by gluing or welding. In the next step 35, an adaptor housing is provided having a bearing channel and having an attachment sleeve configured to frictionally engage the proximal end of the main housing. During performance of this step, the attachment sleeve of the adaptor housing may be integrally formed on the adaptor housing. Next, in step 36, one or more bearings are fitted within the bearing channel of the adaptor housing. Next, step 37 requires installing a driven end of an eccentric shaft through the one or more bearings of the adaptor housing. Preferably, in this step the driven end of the shaft is installed so that the eccentric shaft and the bearings are concentrically aligned with the adaptor housing. Next, in step 38, a drive shaft adaptor is coupled to the driven end of the eccentric shaft. Next, in step 39, a nondriven end of the eccentric shaft is installed within the one or more bearings of the tip cover, preferably so that the eccentric shaft and the bearings are concentrically aligned with the tip cover. In the final step 40, the attachment sleeve of the adaptor housing is bonded to the proximal end of the main housing. The bond may be made permanent by gluing or welding.

A method according to the invention may be performed by supplementing method 30 with additional steps derived from the foregoing disclosure, though such supplemental steps may not be expressly called out in a process step of the flow chart. For example, additional steps in a method according to the present invention may include: providing the adaptor housing having an integral oil seal flange, fitting an oil seal against the integral oil seal flange, and installing the driven end of the eccentric shaft concentrically through the oil seal.

As can be seen in the preferred embodiment, the machining steps necessary to create a sealed concrete vibrator are minimal, thus greatly reducing the cost and ultimate sale price of concrete vibrator assembly 10. It has also been found that a sealed disposable concrete vibrator assembly of the present invention, though of relatively simple and rugged design, has just as long a service life as the much more expensive disassembleable concrete vibrators known in the prior art and that the cost savings realized, when taken together with the avoided cost of replacement bearings and labor to rebuild a more expensive concrete vibrator, more than economically justify the use of the disposable concrete vibrator assembly 10 of the present invention.

While certain preferred embodiments are shown in the figures and described in this disclosure, it is to be distinctly understood that the presently disclosed inventive concepts are not limited thereto but may be variously embodied to practice within the scope of the following claims. From the foregoing description, it will be apparent that various changes may be made without departing from the spirit and scope of the disclosure as defined by the following claims.

What is claimed is:

1. A sealed and disposable concrete vibrator, comprising:
a main housing having open proximal and distal ends;
a rotational eccentric shaft having an eccentric mid portion sized to fit within the main housing between the proximal and distal ends;
a plurality of sealed bearings sized to rotationally support the rotational eccentric shaft while rotating within the main housing, the rotational eccentric shaft having a driven end and a nondriven end;
a tip cover configured to frictionally engage the open distal end of the main housing at which the nondriven end of the rotational eccentric shaft is disposed within the main housing;
coupling means attached to the driven end of the rotational eccentric shaft;
an oil seal means disposed within the proximal end of the main housing and around the driven end of the rotational eccentric shaft between the coupling means and one of the sealed bearings; and
an adaptor housing configured to accommodate the coupling means and to frictionally engage the open proximal end of the main housing.

2. The concrete vibrator of claim 1 wherein the main housing is cylindrical.

3. The concrete vibrator of claim 1 wherein the tip cover comprises an integral attachment sleeve configured to interfit with the open distal end of the main housing.

4. The concrete vibrator of claim 1 wherein the tip cover comprises a channel configured for secure engagement of one or more of the plurality of sealed bearings.

5. The concrete vibrator of claim 1 wherein the adaptor housing comprises an integral attachment sleeve configured to interfit with the open proximal end of the main housing.

6. The concrete vibrator of claim 1 wherein the adaptor housing comprises a channel configured for secure engagement of one or more of the plurality of sealed bearings.

7. The concrete vibrator of claim 1 wherein the adaptor housing comprises an oil seal flange integrally formed on the adaptor housing and configured to arrest longitudinal movement of the oil seal means.

8. The concrete vibrator of claim 1 wherein the tip cover is permanently attached to the distal end of the main housing.

9. The concrete vibrator of claim 1 wherein the adaptor housing is permanently attached to the proximal end of the main housing.

10. The concrete vibrator of claim 1 wherein one or more of the main housing, the tip cover, and the adaptor housing is formed from a hardened steel alloy.

11. The concrete vibrator of claim 1 wherein one or both of the main housing and the tip cover are encased within a plastic or elastomeric material.

12. The concrete vibrator of claim 1 wherein the main housing comprises a hollow cavity at least partially filled with a lubricating medium.

13. A sealed disposable concrete vibrator assembly, comprising:
a hollow cylindrical main housing enclosing a shaft rotationally supported by bearings, the shaft having an eccentric mid portion rotatable within the main housing;
an adaptor housing having a cylindrical protrusion having an outer surface configured to frictionally engage a proximal end of the main housing and having an inner surface configured to frictionally engage one or more of the bearings;
a tip cover having a cylindrical protrusion having an outer surface configured to frictionally engage a distal end of the main housing and having an inner surface configured to frictionally engage one or more of the bearings;
an oil seal compressed against a flange integral to the adaptor housing; and
a circumvolving adaptor coupled through the oil seal to a driven end of the shaft.

14. A method for manufacturing a sealed disposable concrete vibrator, comprising steps for:
providing a main housing having open proximal and distal ends;
providing a tip cover having a bearing channel and having an attachment sleeve configured to frictionally engage the distal end of the main housing;
fitting one or more bearings within the bearing channel of the tip cover;
attaching the attachment sleeve of the tip cover to the distal end of the main housing;
providing an adaptor housing having a bearing channel, and having an attachment sleeve configured to frictionally engage the proximal end of the main housing;
fitting one or more bearings within the bearing channel of the adaptor housing;
installing a driven end of an eccentric shaft concentrically through the one or more bearings of the adaptor housing;
coupling a drive shaft adaptor to the driven end of the eccentric shaft;
installing a nondriven end of the eccentric shaft within the one or more bearings of the tip cover; and
attaching the attachment sleeve of the adaptor housing to the proximal end of the main housing.

15. The method of claim 14 wherein one or both of the attachment sleeve of the tip cover and the attachment sleeve of the adaptor housing comprises an integral attachment sleeve.

16. The method of claim 14
wherein the step for providing the adaptor housing further comprises providing the adaptor housing having an integral oil seal flange;
wherein the method further comprises fitting an oil seal against the integral oil seal flange; and
wherein the step for installing the driven end of the eccentric shaft further comprises installing the driven end of the eccentric shaft concentrically through the oil seal.

17. The method of claim 14 wherein one or both of the attaching steps comprise permanently attaching by gluing or welding.

18. The method of claim 14 wherein the step for installing the driven end of the eccentric shaft further comprises installing the driven end of the eccentric shaft concentrically through the one or more bearings of the adaptor housing.

19. The method of claim 14 wherein the step for installing the nondriven end of the eccentric shaft further comprises installing the nondriven end of the eccentric shaft concentrically within the one or more bearings of the tip cover.

20. The method of claim 14 wherein the main housing has axial symmetry with respect to a longitudinal axis and wherein, at completion of all the steps, one or more of
(a) the tip cover;
(b) the bearings within the bearing channel of the tip cover;
(c) the adaptor housing; and
(d) the bearings within the bearing channel of the adaptor housing;
are concentrically aligned with the longitudinal axis.
